(19) United States
(12) Patent Application Publication
(10) Pub. No.: US 2022/0043848 A1
(43) Pub. Date: Feb. 10, 2022

(54) GENERATING ENTITY RELATION SUGGESTIONS WITHIN A CORPUS

(71) Applicant: International Business Machines Corporation, Armonk, NY (US)

(72) Inventors: Pai-Fang Hsiao, Dublin (IR); Scott Carrier, New Hill, NC (US)

(21) Appl. No.: 16/984,483

(22) Filed: Aug. 4, 2020

(51) Int. Cl. G06F 16/33; G06F 16/28; G06F 16/35; G06F 16/31; G06F 16/338

(52) U.S. Cl. CPC G06F 16/3344; G06F 16/288; G06F 16/338; G06F 16/322; G06F 16/3347; G06F 16/355

(57) ABSTRACT

Aspects of the invention include a computer-implemented method for entity relation type detection. The method includes detecting a plurality of candidate co-occurring entities from one or more documents. A first set of co-occurring entities and a second set of co-occurring entities from the plurality of co-occurring entities is grouped based on a synonymity of a first set of entity types associated with the first set of co-occurring entities and a second set of entity types associated with the second set of co-occurring entities. A synonymity of a first set of intervening tokens associated with the first set of co-occurring entities and a second set of intervening tokens associated with the second set of co-occurring entities is detected. A relation entity type label is generated based on a conflation of two or tokens of the first set of intervening tokens

### BACKGROUND

The present invention generally relates to programmable computing systems, and more specifically, to generating entity relation suggestions within a corpus.

Computer information systems can receive search queries from a user and provide answers back to the user. An information retrieval system can be tasked with automatically answering a question posed in natural language to the system. The information retrieval system can retrieve an answer for the search query by searching a data corpus for documents matching the search query. To assist the information retrieval system, the documents are annotated to describe relationships between co-existing entities. In conventional information retrieval systems, the process of annotating documents is a subjective and labor-intensive process. The quality of the documents retrieved to answer the search query is related to the quality of the annotations.

### SUMMARY

Embodiments of the present invention are directed to discovering entity relations within a corpus for the purpose of suggesting them within a cognitive tooling platform. A non-limiting example computer-implemented method includes detecting a plurality of candidate co-occurring entities from one or more documents. A first set of co-occurring entities and a second set of co-occurring entities from the plurality of co-occurring entities is grouped based on a synonymity of a first set of entity types associated with the first set of co-occurring entities and a second set of entity types associated with the second set of co-occurring entities. A synonymity of a first set of intervening tokens associated with the first set of co-occurring entities and a second set of intervening tokens associated with the second set of co-occurring entities is detected. A relation entity type label is generated based on a conflation of two or tokens of the first set of intervening tokens

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 illustrates a block diagram of components of a system for generating entity relation suggestions accordance with one or more embodiments of the present invention;

FIG. 2 illustrates a flow diagram of a process for generating entity relation suggestions in accordance with one or more embodiments of the present invention;

FIG. 3 illustrates a flow diagram of a process for generating entity relation suggestions in accordance with one or more embodiments of the present invention;

FIG. 4 illustrates a cloud computing environment according to one or more embodiments of the present invention;

FIG. 5 illustrates abstraction model layers according to one or more embodiments of the present invention;

FIG. 6 illustrates a block diagram of a computer system for use in implementing one or more embodiments of the present invention.

The diagrams depicted herein are illustrative. There can be many variations to the diagrams or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

One or more embodiments of the present invention provide computer-implemented methods, computing systems, and computer program products that generate suggestions for entity type annotations based on co-occurring entities and their intervening tokens.

Information systems use trained models to detect entity relations. However, training a model to detect relations in a document is a labor-intensive task. Conventional methods typically begin with collecting documents from a corpus and reviewing the document's text. An annotator reviews the text and refers to an ontology to determine the entity types for words and phrases found in the text. The annotator annotates the words and phrases to associate the words and phrases with respective types of entities. After the text is annotated, a subject matter expert (SME) can review the document to define desired relationships between words and phrases in the text. A computing system can analyze the text, based on the defined relationship, to identify any set of words and phrases that are potentially related according to the SME's definition. The system can present the SME with a set and a list of candidate relation type labels. The SME can decide whether the set has the desired relationship and select a label to annotate a relationship. In other words, the desired relationships are defined upfront, and a computing system uses the definition to extract relevant sets based on the defined relationship.

However, each time that an SME defines a new relation type, the system's entire existing ground truth needs to be manually updated to include new training data with annotations for these newly defined relation types. Furthermore, SMEs often miss text spans over which to insert annotations as they review the training data. In general, SMEs that are not skilled in the art of natural language processing and may not be aware of the relations that could be extracted from the corpus.

One or more embodiments of the present invention address one or more of the above-described shortcomings by providing implemented methods, computing systems, and computer program products that analyze a document to detect annotations for co-occurring entities and their intervening tokens. Co-occurring entities are tokens found in a passage that have a meaningful relationship. The co-occurring entities and the intervening tokens are analyzed using natural language processing techniques. Based on the analysis, the system generates suggested relation type labels for a subject matter expert (SME). In other words, the co-occurring entities are not detected based on a pre-defined relation type, rather the co-occurring entities and their intervening tokens are used to generate a definition of a relation type, and create labels based on the definition.

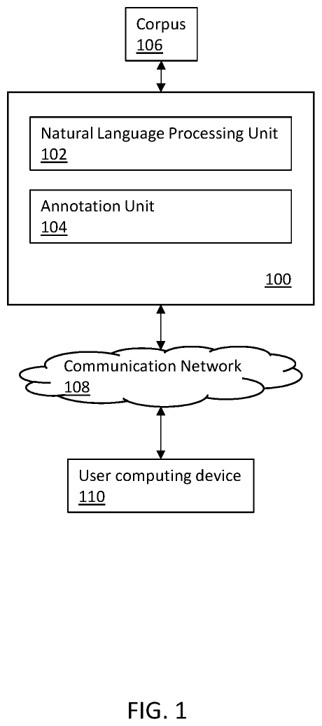

Turning now to FIG. 1, a system 100 for discovering entity relations is generally shown in accordance with one or more embodiments of the present invention. The system 100 includes a natural language processing (NLP) unit 102 for detecting a semantic link between entities of a document passage. The system 100 further includes an annotation unit 104 for generating annotation suggestions for annotation by an SME.

The NLP unit 102 is operable to detect co-occurring tokens in a passage and to determine whether they are semantically related. The NLP unit 102 can receive an electronic document from a corpus 106 or other external source. The document can be segmented into passages, or the NLP unit 102 can apply natural language processing techniques to segment the document into passages. The NLP unit 102 can retrieve individual passages and map the tokens (e.g., words and phrases) in the passage to respective words vectors in a low-dimensional space. The word vectors are numeric representations of the respective words and phrases and denote their semantic meaning. The NLP unit 102 can be trained to detect potential relationships between different word vectors. The potential relationships can be based on patterns found parts of speech, semantic relationships, syntactic relationships, or other appropriate relationships.

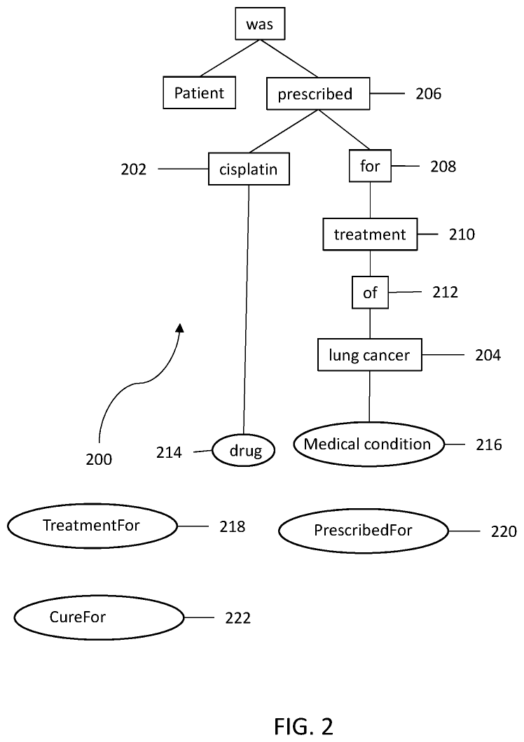

Various methods can be employed to detect co-occurring tokens and determine whether a relationship potentially exists. In an exemplary embodiment of the present invention, the NLP unit 102 can organize a passage into a parse tree as shown in FIG. 2 and described in more detail below. The NLP unit 102 can parse a sentence through various methods, for example, a constituency parsing method. A constituency parsing method involves reconstructing a passage into a constituency-based parse tree describing the passages syntactic structure based on a phase structure grammar. Phase structure grammar is based upon constituency relations between tokens as opposed to dependency relations between tokens. The NLP unit 102 can also employ a dependency parsing method, in which a parse tree is constructed based on a dependency relation between tokens. Although only two methods are described, the NLP unit can employ various methods to organize a passage into a parse tree.

The NLP unit 102 can detect candidate co-occurring entities by detecting patterns in the parse tree that could identify potentially relevant co-occurring entities. The NLP unit 102 can us natural language processing techniques to identify patterns based on a number of characteristics, for example, parts of speech, distance between words, and meanings of words. Co-occurrence is typically defined in the context of relationship frames and semantic/thematic slots. A verb usually encodes a relationship between entities and the corresponding semantic frame defines the semantic slots allowed in that frame. These slots are the entities and are used to determine co-occurrence. For example, for passage the FDA approved the drug”, the verb frame ‘approves’ requires an agent giving the approval, which would be the “FDA”. The verb frame also requires a theme, i.e. something that can be approved, in our context this would be the “drug”. Furthermore, the NLP unit 102 can use well-defined or domain specific verb frame resources to determine semantically compatible co-occurring entities in the context of specific verb/relationships.

Once the NLP unit 102 detects candidate co-occurring entities in a passage, it can analyze the passage to determine whether any patterns exist in the passage that may help identify any other candidate co-occurring entities in other passages. For example, if the NLP unit 102 detected a combination of potentially co-occurring entities based on a semantic meaning of the entities, it can determine a pattern of the intervening tokens that connect the co-occurring entities. The pattern can be, for example, a sequence of a pattern of speech of each word in the intervening tokens. The NLP unit 102 can further search the corpus for passages that have a matching sequence of patterns of speech to detect additional candidate co-occurring entities.

The NLP unit 102 can analyze each passage of each document and detect multiple candidate co-occurring entities. The NLP unit 102 can then divide the detected candidate co-occurring entities into groups, for example, based on synonymity of meaning. To determine whether co-occurring entities have a synonymous meaning, the NLP unit 102 can employ a word embedding model. The NLP unit 102 can detect entity type labels of candidate co-occurring entities and map entity types to respective words vectors in a low-dimensional space. The word vectors are numeric representations of the respective entity types and denote their semantic meaning. The word vectors can be taken as inputs into the word embedding model, which can predict whether one set of co-occurring entities is synonymous with another set of co-occurring entities based on entity types. The prediction can be based on a numerical difference between one word vector and another word vector being below a threshold value/distance.

The NLP unit 102 can traverse each set of co-occurring entities in a group and detect respective sets of intervening tokens. Intervening tokens are words that connect a pair of co-occurring entities within the passage. The NLP unit 102 can employ a word embedding model to determine the synonymity of one set of intervening tokens with another set of intervening tokens with a group. To determine whether intervening tokens have a synonymous meaning, the NLP unit 102 can employ a word embedding model. The NLP unit 102 can map a set of intervening tokens to a word vector in a low-dimensional space. The word vectors are numeric representations of the set intervening tokens and denote their semantic meaning. The word vectors can be taken as inputs into the word embedding model, which can predict whether one set of set intervening tokens is synonymous with another set of set intervening tokens. The determination can be based on a difference between one word vector and another word vector being below a threshold value/distance. The NLP unit 102 further subdivides the groups by grouping co-occurring entities within a group by synonymity of intervening tokens.

The NLP unit 102 can determine that a candidate set of co-occurring entities have a relevant relationship based on the synonymity of co-occurring entities with other co-occurring entities and the synonymity of the intervening tokens. For example, the NLP unit 102 can determine that a set co-occurring entities are synonymous with a threshold number of sets of co-occurring entities within a corpus 106. The NLP unit 102 can also determine that a set of co-occurring entities are synonymous with a threshold percentage of sets of co-occurring entities within a corpus 106. The NLP unit 102 can also determine that a set of intervening tokens are synonymous with a threshold number of sets of intervening tokens within a corpus 106. The NLP unit 102 can also determine that a set of intervening tokens are synonymous with a threshold percentage of sets of intervening tokens within a corpus 106.

The annotation unit 104 can generate candidate entity relation label suggestions for an SME. The entity relation labels can be conflations of the intervening tokens or synonyms of the intervening tokens. The annotation unit 104 can select a combination words from the intervening tokens based on The annotation unit 104 can analyze each set of co-occurring entities that have been grouped based on a synonymity of intervening tokens. The annotation unit 104 can further determine a value for the number of times a set of co-occurring entities is linked by a common token.

The NLP unit 102 can generate a relation type label based on a semantic analysis of a passage. The NLP unit 102 analyzes the intervening tokens and the co-occurring entities to identify the subject and predicate of a passage. The subject and predicate can further be used to identify any predicate frames (sometimes referred to as case frames) in the passage. Predicate frames are structures that define syntactic and semantic properties of a passage, including but not limited to the semantic function of any arguments, a number of arguments, and a syntactic category of a predicate. The NLP unit 102 can generate a relation type label based on the predicate frame. For example, in one instance the NLP unit 102 can have determined that “drug” and “medical condition” are co-occurring entities in passages the corpus 106. The NLP unit 102 can further have determined that “medication” and “patient status” are synonymous co-occurring entities. The NLP unit 102 can further have determined that “is prescribed for”, “is a medication for”, and “is used to treat” are first, second, and third sets of synonymous intervening tokens that connect the co-occurring entities. The annotation unit 104 can determine the frequency of appearance of the first, second, and third set connect the co-occurring entities and synonymous co-occurring entities in the corpus 106. For example, the annotation unit 104 can determine that the set intervening tokens, “is a medication for” appears the most frequently in the corpus 106, the set of intervening tokens, “is prescribed for” appears the second most frequently in the corpus 106, and the set of intervening tokens “is used to treat” appears the third most frequently in the corpus 106.

The annotation unit 104 can then generate label suggestions based on the k-highest number of occurring intervening tokens. For example, if k=2, the annotation unit 104 can select “is a medication for” and “is prescribed for” to generate entity relation suggestions. The annotation unit 104 can semantically analyze the sets of intervening tokens an determine which words to conflate to create the suggestions. The annotation unit 104 can determine the parts of speech for each word in the intervening token and base the suggested labels on the parts of speech. For example, the annotation unit 104 can determine that for the set of intervening tokens “is a medication for”, “medication” is a noun and “for” is and generate a noun-predicate label, such as “Medicationfor”. The annotation unit 104 can also generate entity relation labels based on combinations of other parts of speech.

An SME can review a document via a graphical user interface (GUI). As the SME is scrolling through a document, the annotation unit 104 can visually alert the SME, via the (GUI) of each set of candidate co-occurring entities in a passage. The entity relation labels can be provided to an SME. The annotation unit can receive a selection from the SME and annotate the passage with an entity relation label for the co-occurring entities.

In some embodiments of the present invention, the annotation unit 104 can access a domain specific semantic lexicon to determine whether a connotation of a word from the intervening tokens would be problematic. A semantic lexicon maps words and phrases to semantic types. A domain specific semantic lexicon maps words and phrases to semantic types consistent with a particular domain. The annotation unit 104 can access the semantic lexicon and based on the mapped semantic type, determine that word or phrase should not be selected for use in a suggested entity relation label. For example, the annotation unit 104 can consult with a semantic lexicon for the word “cures” or “cure”. The annotation unit 104 can determine that the word(s) can be problematic in a health care domain based on the associated semantic types. In some embodiments of the present invention, the annotation unit 104 can refer to a domain-specific dictionary that includes a list of words that can be problematic in the domain.

The annotation unit 104 can also determine whether an entity of a co-occurring entity has a static or temporal meaning. A static meaning is not a function of time, whereas a temporal meaning is dependent upon time. The annotation unit 104 can access a lexicon to determine the static or temporal nature of a word or phrase. For example, lung cancer is a medical condition and this does not change over time. As another example, if an entity type is for drugX is “FDA approved, whether drugX is FDA approved is time dependent, as it could be tested prior to approval or have approval revoke after introduction into the market. The annotation unit 104 can further include an additional annotation that the entity is temporal or static. The annotation unit 104 can further annotate a relationship as temporal or static.

The system 100 is operable for receiving electronic data from a corpus 106. The corpus 106 can include electronic medical records from a health care provider, or other appropriate source of electronic documents. The data can include a document, which includes passages, such as topics, paragraphs, sentences, bullet points, and other logical units within a document. The passages can be annotated with labels that are metadata that describe a respective entity type for different tokens found in the passages. In some embodiments of the present invention, the document annotation can be performed prior to receipt by the NLP unit 102. In some embodiments of the present invention, the documents with passages with relation type annotations from an SME are used as training data to train a cognitive model for annotating documents in a corpus.

The system 100 can be in operable communication with a user computing device 110 via a communication network 108. The system 100 can connect to the communication network via a communications port, a wired transceiver, a wireless transceiver, and/or a network card. The communication network 108 can transmit data using technologies such as Ethernet, fiber optics, microwave, xDSL (Digital Subscriber Line), Wireless Local Area Network (WLAN) technology, wireless cellular technology, 5G, Bluetooth technology and/or any other appropriate technology.

The user computing device 110 can be a desktop, laptop, smartphone, or other computing device. A user can operate the user computing device 110 to select a desired entity relation for the NLP unit 102 and the annotation unit 104.

The phrases “neural network” and “machine learning” broadly describes a function of electronic systems that learn from data. A machine learning system, engine, or module can include a machine learning algorithm that can be trained, such as in an external cloud environment (e.g., the cloud computing environment 50), to learn functional relations between inputs and outputs that are currently unknown. In one or more embodiments, machine learning functionality can be implemented using an NLP unit 102 and the relation model unit 104, having the capability to be trained to perform a currently unknown function. In machine learning and cognitive science, neural networks are a family of statistical learning models inspired by the biological neural networks of animals, and in particular, the brain. Neural networks can be used to estimate or approximate systems and functions that depend on a large number of inputs.

The NLP unit 102 and the relation model unit 104 can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in the NLP unit 102 and the relation model unit 104 that carry electronic messages between simulated neurons are provided with numeric weights that correspond to the strength or weakness of a given connection. During training, The weights can be adjusted and tuned based on experience, making the NLP unit 102 and the relation model unit 104 adaptive to inputs and capable of learning. After being weighted and transformed by a function determined by the network's designer, the activation of these input neurons are then passed to other downstream neurons, which are often referred to as “hidden” neurons. This process is repeated until an output neuron is activated. The activated output neuron determines which character was read.

Referring to FIG. 2, an analysis of a parse tree 200 of a sentence for relation detection training data generation is illustrated. The NLP unit 102 and the annotation unit 104 are trained to convert a passage in a document into a parse tree. The parse tree 200 is a data structure that describes the syntactic structure of a passage of a document. In some embodiments of the present invention, NLP unit 102 and the annotation unit 104 can convert each sentence into a parse tree. The term word refers to a syntactic word. Each word or phrase in the sentence is a node of the parse tree. The parse tree includes a root node that is the main verb of the sentence. Each node is connected by an edge indicating the direction of one word or phrase to another in the sentence. Each word or phrase can be tagged with a label indicating a part of speech (e.g., verb, noun, adjective). The sentence illustrated in FIG. 2 would normally read, “Patient was prescribed cisplatin for treatment of lung cancer”. “Cisplatin” 202 and “lung cancer” 204 are an example of co-occurring entities because they both appear within the same sentence boundary. The entity type for “cisplatin” 202, is “drug” 214. The entity type for “lung cancer” 204 is “medical condition” 216. The intervening tokens are for “cisplatin” 202 and “lung cancer” 204 are “prescribed” 206, “for” 208, “treatment” 210, and “of” 212.

The NLP unit 102 can detect the passage “Patient was prescribed cisplatin for treatment of lung cancer” from a document retrieved from the corpus 106. The NLP unit 102 can semantically analyze the passage create a parse tree 200 from the passage. The NLP unit 102 can further detect metadata containing entity type labels such as “drug” 214 for the token “cisplatin” 202 and “medical condition” 216 for the token “lung cancer” 204. The NLP unit 102 can further determine a frequency of occurrence of the entity types or synonyms thereof, and/or the tokens or synonyms thereof in the corpus 106. The NLP unit 102 can determine whether the frequency of occurrence is greater than or less than a threshold value. In the instance that the frequency of occurrence is less than a threshold value, the NLP unit 102 can analyze another set of candidate co-occurring entities. In the instance that the frequency of occurrence is greater than a threshold value, the NLP unit 102 can analyze the intervening tokens connecting the entities. The NLP unit 102 can further group each of the candidate co-occurring entities. Referring to FIG. 2, the NLP unit 102 can analyze the set of intervening tokens “prescribed” 206, “for” 208, “treatment” 210, and “of” 212 (collectively “the first set of intervening tokens)”. The NLP unit 102 can semantically and syntactically analyze the first set tokens for intervening tokens to detect patterns.

For example, referring to FIG. 2, the first set of intervening tokens includes a verb 206 followed by a preposition 208 followed by a noun 210 followed by a preposition 212. This pattern can be converted into a vector and scored. The NLP unit 102 can further determine whether the pattern is similar to patterns found in other sets of intervening tokens in the corpus 106. The similarity between the first set of intervening tokens and a second set of intervening tokens can be based on a respective score of the first and second set of intervening tokens. The NLP unit 102 can determine that the first second and the second set of intervening tokens are similar if the score of the first set of intervening tokens is within an upper bound and lower bound threshold of the score of the second set of intervening tokens. Therefore, two sets of intervening token patterns can be similar without being identical. The NLP unit 102 can further determine whether the first set of intervening tokens is similar to a threshold number of other sets of intervening tokens in the corpus 106. Based on a determination that the first set of intervening tokens is similar to a threshold number of sets of intervening tokens, the NLP unit 102 can determine that “cisplatin” 202 and “lung cancer” 204 are co-occurring entities. The NLP unit 102 can further determine a respective frequency for each set of intervening tokens in the corpus 106.

The annotation unit 104 can conflate words/tokens from the k-highest frequency sets of intervening tokens to generate entity relation label suggestions. For example, the annotation unit can combine tokens from intervening sets to generate “TreatmentFor” 218. If the set of intervening tokens were “is prescribed for”, the annotation unit 104 can generate “PrescribedFor” 220. If the set of intervening tokens were “is a cure for”, the annotation unit 104 can generate “CureFor” 222. As described above, the annotation unit 104 can access a domain specific semantic lexicon to determine whether a connotation of a word from the intervening tokens would be problematic. The word cure has a particular meaning in the healthcare domain, and a writer of a passage may have used the word cure when treatment would have been a better option. Therefore, the annotation unit 104 can remove the candidate entity relation label “CureFor” 220. The annotation unit 104 can present candidate entity relation labels “TreatmentFor” 218 and “PrescribedFor” to an annotator for selection via a display on the user computing device 110.

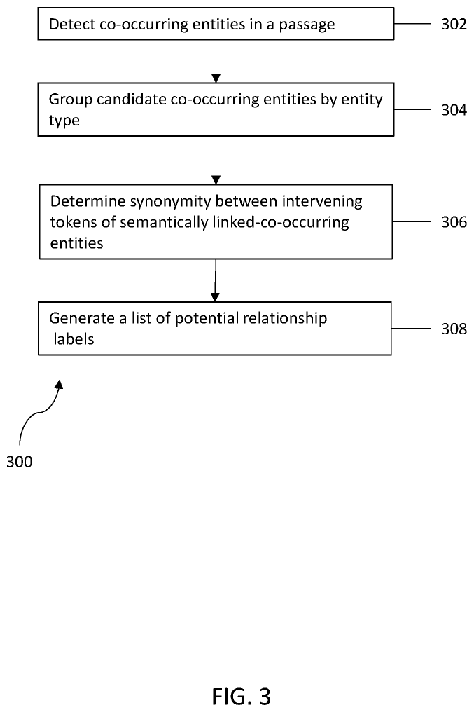

Referring to FIG. 3, a flow diagram 300 of a process for generating entity relation suggestions is shown. At block 302, the method includes detecting co-occurring entities in a passage. A system can receive a plurality of electronic documents from a corpus. The system can employ various natural language processing techniques and segment each document into passages. Each document can have previously been annotated to include labels for the entity types of the tokens found in the passages. The system can retrieve an individual passage and organize the tokens found in the passages into nodes of a parse tree. The system can further analyze the parse tree nodes to determine whether any two or more tokens are candidate co-occurring entities within the passage. Co-occurring entities are two or more tokens found in a passage that are related in a relevant manner for a subject matter expert. The system can then perform a semantic analysis and determine whether entities are co-occurring entities based on patterns, parts of speech, distance between tokens or other appropriate criteria.

At block 304, the system can divide the detected candidate sets of co-occurring entities into groups based on a synonymity of entity types. The system can map each set of entity type to a word vector. Each word vector is a numerical representation of a semantic meaning for each entity of the set of co-occurring entities. The system can then compare two or more word vectors to generate a similarity score that describes the level of similarity between the word vectors. The similarity score can be generated based on various techniques such cosine similarity, Euclidean distance, Jaccard distance, and word mover's distance. The system can then determine whether the similarity score is greater than or less than a threshold value. If the similarity score is greater than the threshold value, the system can determine that the two or more sets of co-occurring entities belong in a same group. If the similarity score is less than the threshold value, the system can determine that the two or more sets of co-occurring entities do not belong in a same group.

At block 306, the system analyzes the sets of intervening tokens within each group to determine synonymity. The system can apply natural language processing techniques and semantically and syntactically each set of intervening tokens. The system can employ a word embedding model to determine the synonymity of one set of intervening tokens with another set of intervening tokens with a group. To determine whether intervening tokens have a synonymous meaning, the system can employ a word embedding model. The system can map a set of intervening tokens to a word vector in a low-dimensional space. The word vectors are numeric representations of the set intervening tokens and denote their semantic meaning. The word vectors can be taken as inputs into the word embedding model, which can predict whether one set of set intervening tokens is synonymous with another set of set intervening tokens. The co-occurring entities within the group are further subdivided based on having synonymous intervening tokens.

At block 308 the system generates a list of potential relationship labels for co-occurring candidate co-occurring entities based on a semantic analysis of a passage. The system analyzes the intervening tokens and the co-occurring entities to identify the subject and predicate of a passage. The subject and predicate can further be used to identify any predicate frames in the passage. Predicate frames are structures that define syntactic and semantic properties of a passage, including but not limited to the semantic function of any arguments, a number of arguments, and a syntactic category of a predicate. The system can generate a relation type label based on the predicate frame by conflating two or more tokens into a single relation type label.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

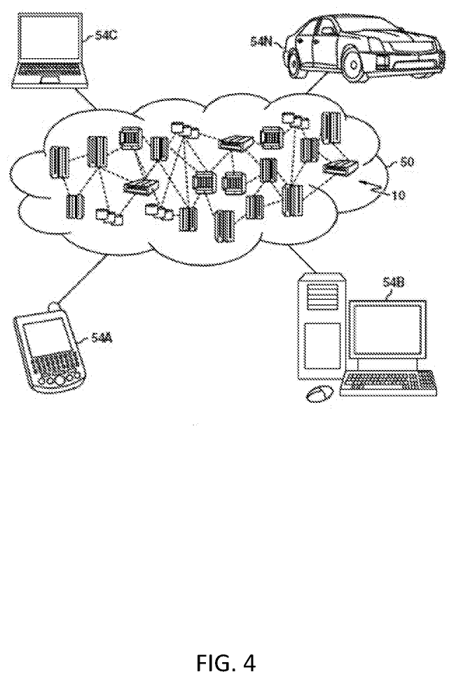

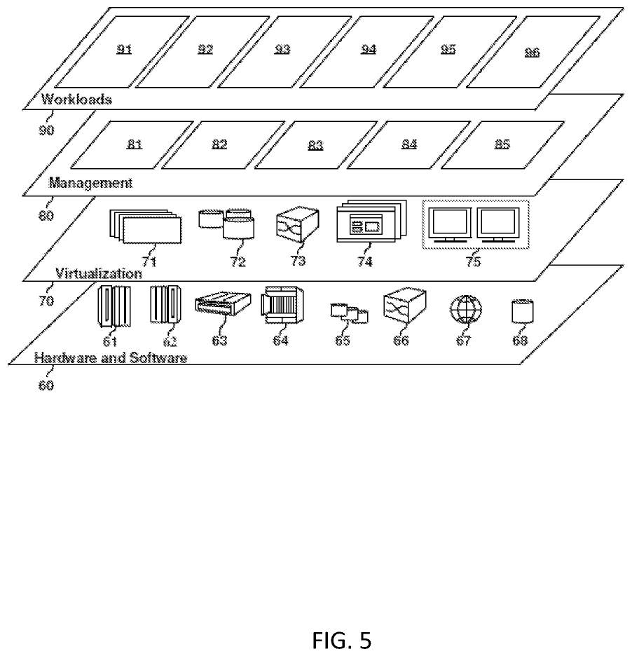

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and generating relationship labels 96.

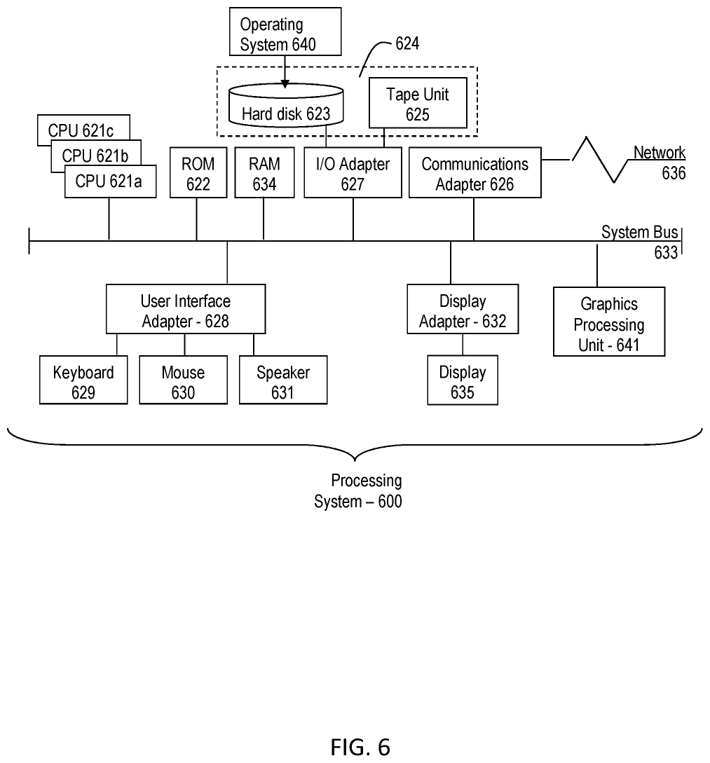

It is understood that the present disclosure is capable of being implemented in conjunction with any other type of computing environment now known or later developed. For example, FIG. 6 depicts a block diagram of a processing system 600 for implementing the techniques described herein. In examples, the processing system 600 has one or more central processing units (processors) 621a, 621b, 621c, etc. (collectively or generically referred to as processor(s) 621 and/or as processing device(s)). In aspects of the present disclosure, each processor 621 can include a reduced instruction set computer (RISC) microprocessor. Processors 621 are coupled to system memory (e.g., random access memory (RAM) 624) and various other components via a system bus 633. Read only memory (ROM) 622 is coupled to system bus 633 and may include a basic input/output system (BIOS), which controls certain basic functions of the processing system 600.

Further depicted are an input/output (I/O) adapter 627 and a network adapter 626 coupled to the system bus 633. I/O adapter 627 may be a small computer system interface (SCSI) adapter that communicates with a hard disk 623 and/or a storage device 625 or any other similar component. I/O adapter 627, hard disk 623, and storage device 625 are collectively referred to herein as mass storage 634. Operating system 640 for execution on processing system 600 may be stored in mass storage 634. The network adapter 626 interconnects system bus 633 with an outside network 636 enabling processing system 600 to communicate with other such systems.

A display (e.g., a display monitor) 635 is connected to the system bus 633 by display adapter 632, which may include a graphics adapter to improve the performance of graphics intensive applications and a video controller. In one aspect of the present disclosure, adapters 626, 627, and/or 632 may be connected to one or more I/O busses that are connected to the system bus 633 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 633 via user interface adapter 628 and display adapter 632. An input device 629 (e.g., a keyboard, a microphone, a touchscreen, etc.), an input pointer 630 (e.g., a mouse, trackpad, touchscreen, etc.), and/or a speaker 631 may be interconnected to system bus 633 via user interface adapter 628, which may include, for example, a Super I/O chip integrating multiple device adapters into a single integrated circuit.

In some aspects of the present disclosure, the processing system 600 includes a graphics processing unit 637. Graphics processing unit 637 is a specialized electronic circuit designed to manipulate and alter memory to accelerate the creation of images in a frame buffer intended for output to a display. In general, graphics processing unit 637 is very efficient at manipulating computer graphics and image processing and has a highly parallel structure that makes it more effective than general-purpose CPUs for algorithms where processing of large blocks of data is done in parallel.

Thus, as configured herein, the processing system 600 includes processing capability in the form of processors 621, storage capability including system memory (e.g., RAM 624), and mass storage 634, input means such as keyboard 629 and mouse 630, and output capability including speaker 631 and display 635. In some aspects of the present disclosure, a portion of system memory (e.g., RAM 624) and mass storage 634 collectively store the operating system 640 to coordinate the functions of the various components shown in the processing system 600.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
detecting, by a processor, a plurality of candidate co-occurring entities from one or more documents;
grouping, by the processor, a first set of co-occurring entities and a second set of co-occurring entities from the plurality of co-occurring entities based on a synonymity of a first set of entity types associated with the first set of co-occurring entities and a second set of entity types associated with the second set of co-occurring entities;
detecting, by the processor, a synonymity of a first set of intervening tokens associated with the first set of co-occurring entities and a second set of intervening tokens associated with the second set of co-occurring entities; and
generating, by the processor, a relation entity type label based on a conflation of two or tokens of the first set of intervening tokens.

2. The computer-implemented method of claim 1, wherein the synonymity between the first set of co-occurring entities and the second set of co-occurring entities is determined as follows:
mapping the first set of co-occurring entities to a first word vector and mapping the second set of co-occurring entities to a second word vector;
comparing the first word vector to the second word vector to determine a distance between the first word vector and the second word vector; and
determined whether the distance is greater than or less than a threshold distance.

3. The computer-implemented method of claim 1, wherein detecting the first set of intervening tokens is as follows:
detecting a first entity and a second entities of the first set of co-occurring entities in a passage from the one or more documents;
organizing the passage into a tree data structure, wherein each token of the passage is a node of the tree, and each node is connected to at least one other node by an edge in a same sequence as the passage;
detecting a set of sequential nodes connecting the first entity and the second entity.

4. The computer-implemented method of claim 1, wherein the synonymity between the first set of intervening tokens and the second set of intervening tokens is determined as follows:
mapping the first set of intervening tokens to a first word vector and mapping the second set of intervening tokens to a second word vector;
comparing the first word vector to the second word vector to determine a distance between the first word vector and the second word vector; and
determined whether the distance is greater than or less than a threshold distance.

5. The computer-implemented method of claim 1 further comprising:
determining a token used to generate the relationship type label has a temporal meaning; and
generating a temporal meaning label.

6. The computer-implemented method of claim 1 further comprising:
presenting, via a graphical user interface, the relation type label simultaneously to presenting, via the graphical user interface a passage from which the first set of co-occurring entities are found.

7. The computer-implemented method of claim 6 further comprising:
receiving a selection of the relation type label; and
introducing a metadata annotation label to the passage to describe a relationship between a first entity and a second entity of the first set of co-occurring entities.

8. A system comprising:
a memory having computer readable instructions; and
one or more processors for executing the computer readable instructions, the computer readable instructions controlling the one or more processors to perform operations comprising:
detecting a plurality of candidate co-occurring entities from one or more documents;
grouping a first set of co-occurring entities and a second set of co-occurring entities from the plurality of co-occurring entities based on a synonymity of a first set of entity types associated with the first set of co-occurring entities and a second set of entity types associated with the second set of co-occurring entities;
detecting a synonymity of a first set of intervening tokens associated with the first set of co-occurring entities and a second set of intervening tokens associated with the second set of co-occurring entities; and
generating a relation entity type label based on a conflation of two or tokens of the first set of intervening tokens.

9. The system of claim 8, wherein the synonymity between the first set of co-occurring entities and the second set of co-occurring entities is determined as follows:
mapping the first set of co-occurring entities to a first word vector and mapping the second set of co-occurring entities to a second word vector;
comparing the first word vector to the second word vector to determine a distance between the first word vector and the second word vector; and
determined whether the distance is greater than or less than a threshold distance.

10. The system of claim 8, wherein detecting the first set of intervening tokens is as follows:
detecting a first entity and a second entities of the first set of co-occurring entities in a passage from the one or more documents;
organizing the passage into a tree data structure, wherein each token of the passage is a node of the tree, and each node is connected to at least one other node by an edge in a same sequence as the passage;
detecting a set of sequential nodes connecting the first entity and the second entity.

11. The system of claim 8, wherein the synonymity between the first set of intervening tokens and the second set of intervening tokens is determined as follows:
mapping the first set of intervening tokens to a first word vector and mapping the second set of intervening tokens to a second word vector;
comparing the first word vector to the second word vector to determine a distance between the first word vector and the second word vector; and
determined whether the distance is greater than or less than a threshold distance.

12. The system of claim 8, wherein the operations further comprise:
determining a token used to generate the relationship type label has a temporal meaning; and
generating a temporal meaning label.

13. The system of claim 8, wherein the operations further comprise:
presenting, via a graphical user interface, the relation type label simultaneously to presenting, via the graphical user interface a passage from which the first set of co-occurring entities are found.

14. The system of claim 13, wherein the operations further comprise:
receiving a selection of the relation type label; and
introducing a metadata annotation label to the passage to describe a relationship between a first entity and a second entity of the first set of co-occurring entities.

15. A computer program product comprising a computer readable storage medium having program instructions embodied therewith, the program instructions executable by a processor to cause the processor to perform operations comprising:
detecting a plurality of candidate co-occurring entities from one or more documents;
grouping a first set of co-occurring entities and a second set of co-occurring entities from the plurality of co-occurring entities based on a synonymity of a first set of entity types associated with the first set of co-occurring entities and a second set of entity types associated with the second set of co-occurring entities;
detecting a synonymity of a first set of intervening tokens associated with the first set of co-occurring entities and a second set of intervening tokens associated with the second set of co-occurring entities; and
generating a relation entity type label based on a conflation of two or tokens of the first set of intervening tokens.

16. The computer program product of claim 15, wherein the synonymity between the first set of co-occurring entities and the second set of co-occurring entities is determined as follows:
mapping the first set of co-occurring entities to a first word vector and mapping the second set of co-occurring entities to a second word vector;
comparing the first word vector to the second word vector to determine a distance between the first word vector and the second word vector; and
determined whether the distance is greater than or less than a threshold distance.

17. The computer program product of claim 15, wherein detecting the first set of intervening tokens is as follows:
detecting a first entity and a second entities of the first set of co-occurring entities in a passage from the one or more documents;
organizing the passage into a tree data structure, wherein each token of the passage is a node of the tree, and each node is connected to at least one other node by an edge in a same sequence as the passage;
detecting a set of sequential nodes connecting the first entity and the second entity.

18. The computer program product of claim 15, wherein the synonymity between the first set of intervening tokens and the second set of intervening tokens is determined as follows:
mapping the first set of intervening tokens to a first word vector and mapping the second set of intervening tokens to a second word vector;
comparing the first word vector to the second word vector to determine a distance between the first word vector and the second word vector; and
determined whether the distance is greater than or less than a threshold distance.

19. The computer program product of claim 15, the operations further comprising:
determining a token used to generate the relationship type label has a temporal meaning; and
generating a temporal meaning label.

20. The computer program product of claim 15, the operations further comprising:
presenting, via a graphical user interface, the relation type label simultaneously to presenting, via the graphical user interface a passage from which the first set of co-occurring entities are found.
